(19) United States
(12) Patent Application Publication
(10) Pub. No.: US 2026/0063938 A1
(43) Pub. Date: Mar. 5, 2026

(54) DISPLAY DEVICE HAVING SWITCHABLE VIEWING ANGLE

(71) Applicant: LG Display Co., Ltd., Seoul (KR)

(72) Inventors: JaeJung HAN, Paju-si (KR); SeMin Lee, Paju-si (KR)

(73) Assignee: LG Display Co., Ltd., Seoul (KR)

(21) Appl. No.: 19/285,946

(22) Filed: Jul. 30, 2025

(30) Foreign Application Priority Data
Aug. 30, 2024 (KR) 10-2024-0117969

(51) Int. Cl. G02F 1/13; G02F 1/1335; G02F 1/1343

(52) U.S. Cl. CPC G02F 1/1323; G02F 1/133526; G02F 1/133531; G02F 1/13439

(57) ABSTRACT

A display device having a switchable viewing angle in one example includes a display panel having a display area and a non-display area around the display area. The display area can include a viewing angle control area in which the display device is operated to be switched between a viewing angle control mode and a share mode, a share area in which the display device is operated in the share mode, and a boundary area disposed between the viewing angle control area and the share area and in which the display device is operated to be switched between the viewing angle control mode and the share mode. The display device can further include a viewing angle control panel disposed below the display panel and configured to selectively control the operating mode of the display device by controlling a polarized light transmitting into the display area.

### CROSS-REFERENCE TO RELATED APPLICATIONS

This application claims priority to Korean Patent Application No. 10-2024-0117969 filed on Aug. 30, 2024, in the Republic of Korea, the entire disclosure of which is incorporated by reference.

### BACKGROUND

### Field

The present disclosure relates to a display device having a switchable viewing angle.

### Description of the Related Art

In general, display devices are being widely used for display screens of various products such as televisions, laptop computers, monitors, and automated teller machines (ATMs) at banks as well as portable electronic devices such as mobile communication terminals, electronic notebooks, e-books, portable multimedia players (PMPs), navigation systems, ultra-mobile PCs (UMPCs), mobile phones, smartphones, and tablet personal computers (PCs).

Viewing angle characteristics of the display device are very important.

The display device needs to be able to implement image quality that is clear and undistorted even within a wide viewing angle range. Therefore, a wide-viewing-angle technology is being consistently developed.

However, in case that information displayed by the display device is not allowed to be seen by other persons located nearby, a narrow-viewing-angle mode (privacy mode), which is needed to enable only the person seated in front of the screen to see images on the screen in case that working on confidential documents is performed or tasks, which require security, are performed, is also required in addition to a wide-viewing-angle mode (normal mode).

Meanwhile, recently, there has been an increasing demand for display devices in which the wide-viewing-angle mode and the narrow-viewing-angle mode are combined. The display device distinguishes pieces of information or areas displayed by the display device, displays particular areas or particular information in the narrow-viewing-angle mode, and displays other areas or information in the wide-viewing-angle mode. In this case, there can occur a limitation in that display quality is degraded by heterogeneity in a boundary area in which the information or area is displayed in two types of modes.

### SUMMARY OF THE DISCLOSURE

An object to be achieved by the present disclosure is to provide a display device having a switchable viewing angle, the display device being capable of switching between a privacy mode and a normal mode (or a share mode) and particularly improving luminance without increasing power consumption in the share mode.

Another object to be achieved by the present disclosure is to provide a display device having a switchable viewing angle, the display device being capable of improving image quality by reducing the visual inconsistency caused by a difference between modes displayed in an area between a privacy mode and a share mode.

Still another object to be achieved by the present disclosure is to provide a display device having a switchable viewing angle, the display device being capable of improving efficiency and process performance.

Objects of the present disclosure are not limited to the above-mentioned objects, and other objects, which are not mentioned above, can be clearly understood by those skilled in the art from the following descriptions.

A display device having a switchable viewing angle according to an embodiment of the present disclosure can include: a display panel comprising a display area and a non-display area around the display area, the display area including a viewing angle control area in which the display device is operated to be switched between a viewing angle control mode and a share mode, a share area in which the display device is operated in a share mode, and a boundary area disposed between the viewing angle control area and the share area in which the display device is operated to be switched between the viewing angle control mode and the share mode, a viewing angle control panel disposed below the display panel for selectively controlling the operating mode of the display device by controlling the polarized light transmitting into the display area, wherein in an area of the viewing angle control panel corresponding to the boundary area, the viewing angle control panel is configured so that the amount of the polarized light from a light source of the display device blocked by the viewing angle control panel gradually decreases in a direction from the viewing angle control area to the share area.

A display device having a switchable viewing angle according to another embodiment of the present disclosure can include: a display panel comprising a display area and a non-display area around the display area, the display area including a viewing angle control area in which the display device is operated to be switched between a viewing angle control mode and a share mode, a share area in which the display device is operated in the share mode, and a boundary area disposed between the viewing angle control area and the share area in which the display device is operated to be switched between the viewing angle control mode and the share mode, a viewing angle control panel disposed below the display panel for selectively controlling the operating mode of the display device, wherein the viewing angle control panel comprises: a first polarizing plate; a viewing angle control layer disposed on the first polarizing plate; and a second polarizing plate disposed on the viewing angle control layer and having a transmission axis perpendicular to a transmission axis of the first polarizing plate, wherein the viewing angle control layer comprises a plurality of upper electrodes, at least one lower electrode and a liquid crystal layer disposed between the upper electrodes and the lower electrode, wherein, in an area of the viewing angle control panel corresponding to the boundary area, a width of each of the plurality of upper electrodes in the direction from the viewing angle control area to the share area gradually decreases in a direction from the viewing angle control area to the share area.

A display device having a switchable viewing angle according to another embodiment of the present disclosure can include: a display panel comprising a display area and a non-display area around the display area, the display area including a viewing angle control area in which the display device is operated to be switched between a viewing angle control mode and a share mode, a share area in which the display device is operated in the share mode, and a boundary area disposed between the viewing angle control area and the share area in which the display device is operated to be switched between the viewing angle control mode and the share mode, a viewing angle control panel disposed below the display panel for selectively controlling the operating mode of the display device, wherein the viewing angle control panel comprises: a first polarizing plate; a viewing angle control layer disposed on the first polarizing plate; and a second polarizing plate disposed on the viewing angle control layer and having a transmission axis perpendicular to a transmission axis of the first polarizing plate, wherein the viewing angle control layer comprises a plurality of upper electrodes, at least one lower electrode and a liquid crystal layer disposed between the upper electrodes and the lower electrode, wherein, in an area of the viewing angle control panel corresponding to the boundary area, a voltage applied to the plurality of upper electrodes in the viewing angle control mode is applied in a manner that the voltage gradually decreases in a direction from the viewing angle control area to the share area.

Other detailed matters of the embodiments are included in the detailed description and the drawings.

The present disclosure can provide the display device having a switchable viewing angle that can switch between the privacy mode and the share mode by controlling the polarized state and the optical path of the light source and improve luminance without an increase in power consumption particularly in the share mode.

The present disclosure can provide the display device having a switchable viewing angle that can increase a speed of switching between the privacy mode and the share mode by using the twisted nematic (TN) liquid crystal with a high response speed of controlling the optical path.

The present disclosure can provide the display device having a switchable viewing angle that can collect light by using the pixel lens and improve efficiency and process performance by using glass for the base substrate.

The effects according to the present disclosure are not limited to the contents exemplified above, and more various effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration view schematically illustrating a display device having a switchable viewing angle according to embodiments of the present disclosure;

FIG. 2 is a view illustrating the display device having a switchable viewing angle according to the embodiments of the present disclosure;

FIGS. 3A and 3B are cross-sectional views illustrating an example of a part of a display device having a switchable viewing angle according to a first embodiment of the present disclosure;

FIGS. 4A and 4B are top plan views illustrating an example of a part of the display device having a switchable viewing angle according to the first embodiment of the present disclosure;

FIG. 5 is a cross-sectional view illustrating an example of a part of a display device having a switchable viewing angle according to a second embodiment of the present disclosure;

FIG. 6A is a view illustrating a state in which the display device having a switchable viewing angle according to the second embodiment of the present disclosure in FIG. 5 is in a share mode;

FIG. 6B is a view illustrating a state in which the display device having a switchable viewing angle according to the second embodiment of the present disclosure in FIG. 5 is in a privacy mode;

FIG. 7 is a top plan view illustrating a viewing angle control area, a share area, and a boundary area between the two areas of the display device;

FIGS. 8A and 8B are schematic cross-sectional views of a viewing angle control panel taken along line A to A′ in FIG. 7; and

FIGS. 9A and 9B are schematic cross-sectional views for explaining another configuration of the viewing angle control panel taken along line A to A′ in FIG. 7.

### DETAILED DESCRIPTION OF THE EMBODIMENTS

Advantages and characteristics of the present disclosure and a method of achieving the advantages and characteristics will be clear by referring to embodiments described below in detail together with the accompanying drawings. However, the present disclosure is not limited to the embodiments disclosed herein but will be implemented in various forms. The embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the specification. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are used with the term “immediately” or “directly”.

When an element or layer is disposed “on” another element or layer, the element or lay can be directly on the another element or lay, or other layer(s) or element(s) can be interposed therebetween.

Although the terms “first”, “second”, and the like are used for describing various components, these components are not confined by these terms. These terms are merely used for distinguishing one component from the other components and may not define order or sequence. Therefore, a first component to be mentioned below can be a second component in a technical concept of the present disclosure. Further, the term “can” fully encompasses all the meanings and coverages of the term “may” and vice versa.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, various embodiments of the present disclosure will be described in detail with reference to the drawings. All the components of each display device/apparatus according to all embodiments of the present disclosure are operatively coupled and configured.

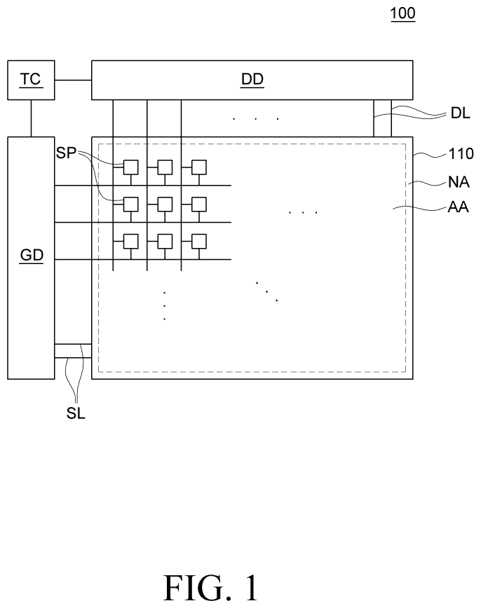

FIG. 1 is a configuration view schematically illustrating a display device having a switchable viewing angle according to embodiments of the present disclosure.

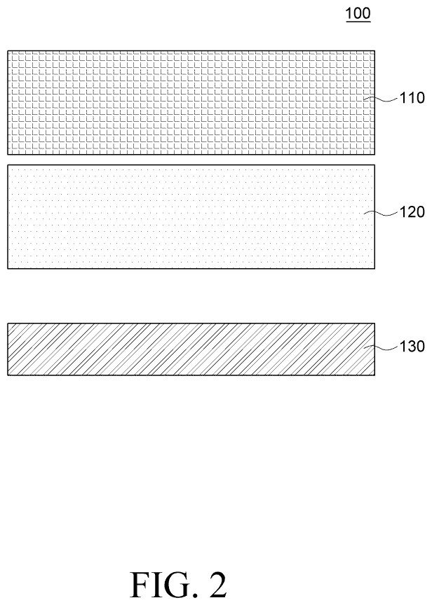

FIG. 2 is a view illustrating the display device having a switchable viewing angle according to the embodiments of the present disclosure.

For convenience of description, FIG. 1 illustrates a display panel 110, a gate driver GD, a data driver DD, and a timing controller TC among various constituent elements of a display device 100 having a switchable viewing angle.

With reference to FIG. 1, the display device 100 having a switchable viewing angle of the embodiments of the present disclosure can include the display panel 110 including a plurality of subpixels SP, and the gate driver GD, the data driver DD, and the timing controller TC configured to supply various types of signals to the display panel 110.

The gate driver GD can supply a plurality of scan signals to a plurality of scan lines SL in response to a plurality of gate control signals provided from the timing controller TC. FIG. 1 illustrates that the single gate driver GD is disposed to be spaced apart from one side of the display panel 110. However, the number and arrangement of the gate driver GD are not limited thereto.

The data driver DD can convert image data, which are inputted from the timing controller TC, into a data voltage by using a reference gamma voltage in response to a plurality of data control signals provided from the timing controller TC. The data driver DD can supply the converted data voltage to a plurality of data lines DL.

The timing controller TC can align image data, which is inputted from the outside, and supply the image data to the data driver DD. The timing controller TC can generate the gate control signals and the data control signals by using synchronizing signals, i.e., dot clock signals, data enable signals, and horizontal/vertical synchronizing signals inputted from the outside. Further, the timing controller TC can control the gate driver GD and the data driver DD by supplying the generated gate control signals and data control signals to the gate driver GD and the data driver DD.

The display panel 110 can be configured to display images to the user and include the plurality of subpixels SP. In the display panel 110, the plurality of scan lines SL and the plurality of data lines DL can intersect one another, and each of the plurality of subpixels SP can be connected to the scan line SL and the data line DL. In addition, the plurality of subpixels SP can each be connected to a high-potential power line, a low-potential power line, a reference line, or the like. However, the present disclosure is not limited thereto.

The display panel 110 can have a display area (or active area) AA, and a non-display area (or non-active area) NA configured to surround the display area AA.

The display area AA is an area of the display panel 110 in which images are displayed.

The display area AA can include the plurality of subpixels SP constituting a plurality of pixels, and a circuit configured to operate the plurality of subpixels SP. The plurality of subpixels SP is minimum units that constitute the display area AA. The n subpixels SP can constitute a single pixel. All types of display panels, such as liquid crystal display panels, organic electroluminescent display panels, quantum dot display panels, and electroluminescent display panels, can be used as the display panel 110 used in the embodiments of the present disclosure.

A plurality of lines for transmitting various types of signals to the plurality of subpixels SP can be disposed in the display area AA. For example, the plurality of lines can include the plurality of data lines DL for supplying data voltages to the plurality of subpixels SP, and the plurality of scan lines SL for supplying scan signals to the plurality of subpixels SP. The plurality of scan lines SL can extend in one direction in the display area AA and be connected to the plurality of subpixels SP. The plurality of data lines DL can extend in a direction different from one direction in the display area AA and be connected to the plurality of subpixels SP. In addition, a low-potential power line, a high-potential power line, and the like can be further disposed in the display area AA. However, the present disclosure is not limited thereto.

The non-display area NA is an area in which no image is displayed. The non-display area NA can be defined as an area extending from the display area AA. The non-display area NA can include link lines and pad electrodes for transmitting signals to the subpixels SP in the display area AA. Alternatively, the non-display area NA can include drive ICs such as gate driver ICs and data driver ICs.

However, the non-display area NA can be positioned on a rear surface of the display panel 110, i.e., a surface on which the subpixel SP is not present. Alternatively, the non-display area NA can be excluded. However, the present specification is not limited to the configuration illustrated in the drawings.

The drivers such as the gate driver GD, the data driver DD, and the timing controller TC can be connected to the display panel 110 in various ways. For example, the gate driver GD can be mounted in the non-display area NA in a gate-in-panel (GIP) manner. In addition, the data driver DD and the timing controller TC can be formed on a separate flexible film and the printed circuit board. The data driver DD and the timing controller TC can be electrically connected to the display panel 110 by bonding the flexible film and the printed circuit board to the pad electrode formed in the non-display area NA of the display panel 110.

Meanwhile, with reference to FIG. 2, the display device 100 having a switchable viewing angle of the present disclosure can broadly include the display panel 110 configured to display an image, a viewing angle control panel 120 disposed above or below the display panel 110 and configured to selectively control a viewing angle range in which the image implemented by the display panel 110 is displayed, and aback light unit 130 positioned below the viewing angle control panel 120.

FIG. 2 illustrates an example in which the viewing angle control panel 120 is disposed below the display panel 110. However, the present disclosure is not limited thereto. The viewing angle control panel 120 can be disposed above the display panel 110.

For example, in case that the display panel 110 is configured as a liquid crystal display panel, the display panel 110 can include a first substrate, a second substrate, and a liquid crystal layer interposed between the first substrate and the second substrate.

The first substrate, which is a TFT array substrate, can include a gate line and a data line configured to define a pixel area while intersecting each other, and a thin-film transistor formed in an intersection portion where the gate line and the data line intersect.

Further, for example, a plurality of common electrodes and a plurality of pixel electrodes can be disposed alternately in pixel areas of the first substrate and implement images.

In addition, a black matrix having opening portions corresponding to the pixel areas can be disposed on the second substrate that is a color filter substrate. A color filter layer including red, green, and blue color filters sequentially and repeatedly arranged to correspond to the opening portions can be disposed on the second substrate.

Further, an overcoating layer can be disposed above the black matrix and the color filter layer.

In addition, a lower polarizing plate and an upper polarizing plate can be respectively attached to an outer surface of the first substrate and an outer surface of the second substrate and configured to selectively transmit particular light. For convenience of description, the lower polarizing plate and the upper polarizing plate can be respectively referred to as a third polarizing plate and a fourth polarizing plate.

In this case, polarization axes of the third and fourth polarizing plates can be orthogonal to each other.

The viewing angle control panel 120 can be disposed above or below the display panel 110. For example, the viewing angle control panel 120 of the present disclosure can broadly include a viewing angle control layer, and polarizing plates disposed above and below the viewing angle control layer. The viewing angle control panel 120 can selectively provide light suitable for the privacy mode or the share mode by controlling a polarized state of the light for each area in accordance with whether a voltage is applied to an electrode provided in the viewing angle control layer.

The back light unit 130 can be disposed below the viewing angle control panel 120. For example, the back light unit 130 of the present disclosure can provide polarized light (e.g., P-waves or S-waves).

The back light unit 130 can include a light source such as an incandescent lamp, a fluorescent lamp, or a light-emitting diode (LED). The light emitted from the light source is provided to the display panel 110 through the viewing angle control panel 120, such that images can be implemented.

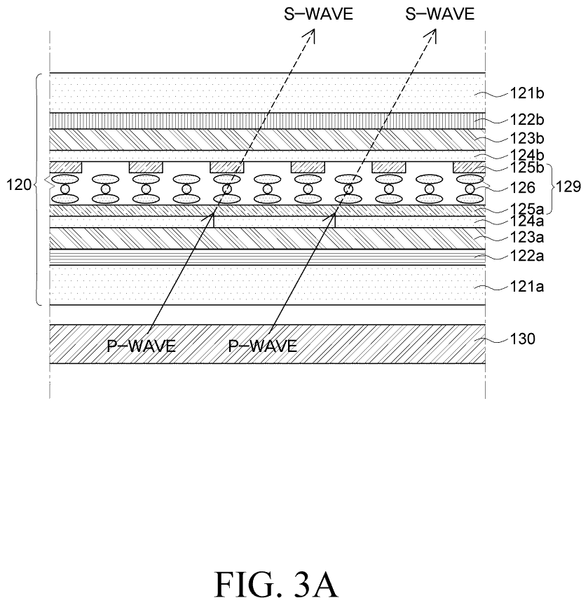

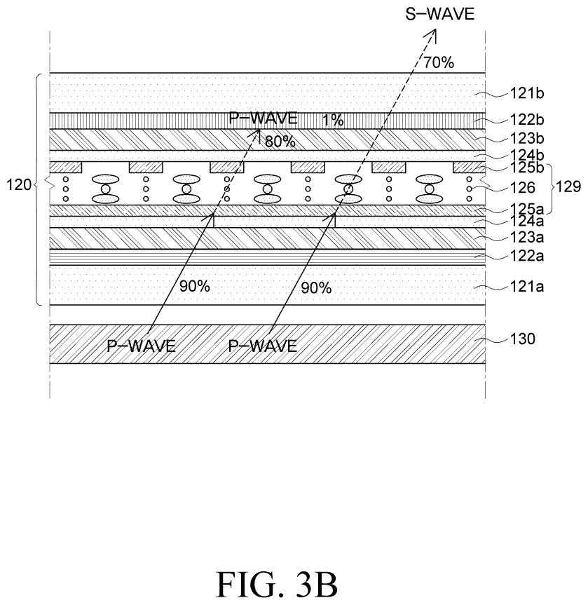

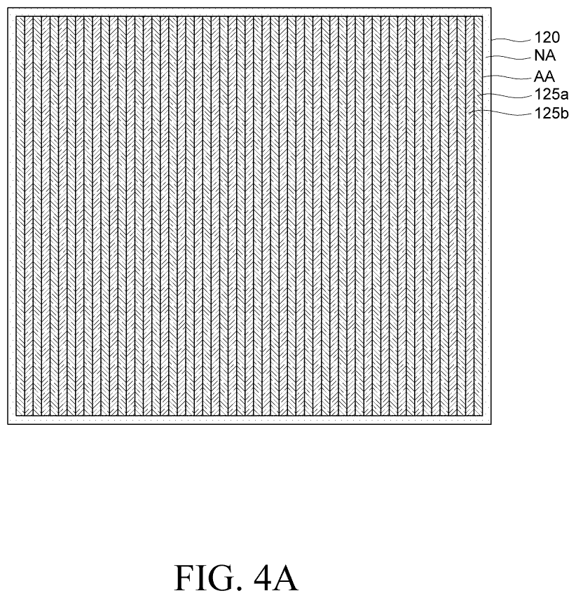

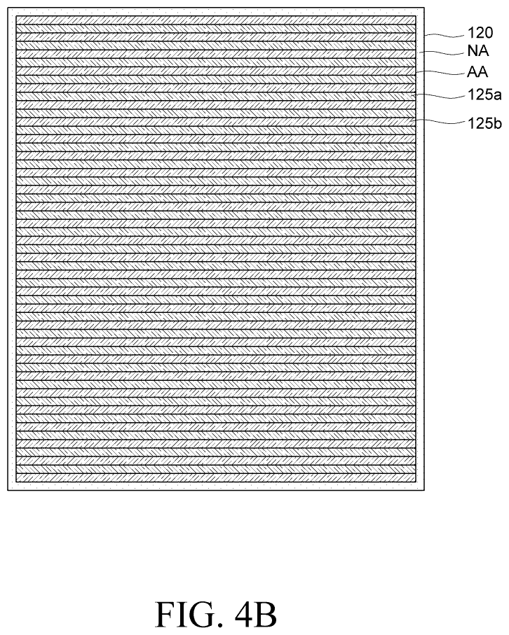

Hereinafter, the viewing angle control panel 120 and the back light unit 130 will be described in detail with reference to FIGS. 3A, 3B, 4A, and 4B.

FIGS. 3A and 3B are cross-sectional views illustrating a part of a display device having a switchable viewing angle according to a first embodiment of the present disclosure. FIGS. 4A and 4B are top plan views illustrating a part of the display device having a switchable viewing angle according to the first embodiment of the present disclosure.

Particularly, FIGS. 3A and 3B illustrate structures of the viewing angle control panel 120 and the back light unit 130 according to the first embodiment of the present disclosure.

For convenience of description, FIGS. 3A and 3B illustrate a part of the display device having a switchable viewing angle from which the display panel is excluded. The display panel can be disposed on an upper or lower portion of the viewing angle control panel 120 or attached, in an add-on shape, to the upper or lower portion of the viewing angle control panel 120.

FIG. 3A illustrates the display device having a switchable viewing angle in a state in which no voltage is applied to a pair of electrodes 125a and 125b. FIG. 3B illustrates the display device having a switchable viewing angle in a state in which a voltage is applied to the pair of electrodes 125a and 125b. FIGS. 3A and 3B illustrate a change in polarized states of the light in accordance with whether a voltage is applied. In addition, FIGS. 4A and 4B illustrate the arrangement of the pair of electrodes 125a and 125b.

With reference to FIGS. 3A, 3B, 4A, and 4B, the back light unit 130 can be disposed below the viewing angle control panel 120.

For example, the back light unit 130 according to the first embodiment of the present disclosure can provide light polarized to the P-wave or the S-wave by applying a polarization light source.

In a related art, light, which is emitted from the light source and is not polarized, is primarily polarized by using the lower polarizing plate, a direction of the polarized light is controlled by using the liquid crystal layer, and the light is secondarily polarized again by using the upper polarizing plate, such that an image is implemented. In the related art described above, because the light primarily polarized by using the lower polarizing plate is used, a majority (about 50%) of the light emitted from the light source is lost by being blocked by the lower polarizing plate. Because the light passes through many layers and various types of films including the polarizing plate, the amount of light, which finally implements an image, is less than 10% of a total amount of light.

Meanwhile, a reflective polarized dual brightness enhancement film (DBEF) (Vikuiti™ DBEF) for reducing overall power consumption by reducing a loss of light has been developed and used. The reflective polarized DBEF transmits polarized waves (e.g., P-waves) polarized in one direction of the light entering the DBEF and reflects polarized waves (e.g., S-waves) polarized in another direction. In addition, the light reflected by the reflective polarized DBEF is reflected by a reflective film. The DBEF transmits the polarized wave polarized in one direction of the reflected light and reflects the polarized waves polarized in another direction. That is, the reflective polarized DBEF can increase a utilization rate of light by using both reflection and polarization. However, because a loss of light occurs when the light is reflected, the DBEF has a limitation in reducing a loss of light. In addition, the reflective polarized DBEF has a disadvantage of high manufacturing costs.

Therefore, the first embodiment of the present disclosure uses the back light unit 130 that adopts the polarization light source, such that it is possible to reduce overall power consumption of the display device having a switchable viewing angle by reducing a loss of light and to implement an image without using a lower polarizing film and/or the reflective polarized DBEF, thereby reducing costs.

For example, the back light unit 130 can include a non-polar LED as a light source. In addition, the back light unit 130 can further include a diffusion plate for mixing light emitted from the light source, and a brightness enhancement film (BEF). However, the present disclosure is not limited thereto.

For example, the LEDs can define an array by being aligned on an upper portion of a substrate such as a printed circuit board and include red, green, and blue LEDs or include a white LED. The LEDs constitute an LED module by being regularly arranged on the upper portion of the printed circuit board. In addition, a plurality of LED modules can be used to supply light to the viewing angle control panel 120. For example, a reflective film can be positioned below a light emergent surface of the LED and reflect the light, which is emitted from the LED, upward. In addition, the LED can be provided in the form of a package equipped with a non-polar light-emitting diode chip.

The light, which is emitted from the LED and polarized to the P-wave or the S-wave while passing through the diffusion plate and the BEF, enters the viewing angle control panel 120. FIGS. 3A and 3B illustrate an example in which the light polarized to the P-wave enters the viewing angle control panel 120. However, the present disclosure is not limited thereto. The light polarized to the S-wave can enter the viewing angle control panel 120.

In general, the polarizing plate used for the liquid crystal display panel requires a polarization degree of 98 to 100%, and thus a transmittance rate cannot exceed about 40 to 50%. However, in the present disclosure, for example, a polarizing plate, in which a polarization degree is 70 to 90% and a transmittance rate is 60 to 80%, can be used as the lower polarizing plate of the viewing angle control panel 120.

Next, the viewing angle control panel 120 according to the first embodiment of the present disclosure can broadly include a viewing angle control layer 129, and first and second polarizing plates 122a and 122b respectively disposed below and above the viewing angle control layer 129.

For example, the first polarizing plate 122a can have a transmission axis consistent with a polarization direction of back light. For example, in case that the back light has a horizontal polarization of the P-wave, the first polarizing plate 122a can have a transmission axis of 0° and an absorption axis of 90°.

For example, the second polarizing plate 122b can have a transmission axis perpendicular to the polarization direction of the back light. For example, in case that the back light has the horizontal polarization of the P-wave, the second polarizing plate 122b can have a transmission axis of 90° and an absorption axis of 0°. That is, the transmission axis of the second polarizing plate 122b can be perpendicular to the transmission axis of the first polarizing plate 122a.

For reference, the polarizing plate includes a polarizing film having a polarization function. The polarizing film can be formed by adsorbing iodine or a dichroic dye on a layer of polyvinyl alcohol (PVA) stretched in a particular direction. In this case, the transmission axis can be formed in a direction orthogonal to the stretch direction.

For example, a first TAC (triacetate cellulose) layer 121a and a second TAC layer 121b can be respectively disposed outside the first polarizing plate 122a and the second polarizing plate 122b. In addition, an adhesive layer can be further disposed outside the second TAC layer 121b. The adhesive layer is a layer made of an adhesive agent that allows the viewing angle control panel 120 to be adhered to the display panel. For example, the adhesive layer can include a pressure sensitive adhesive (PSA).

For example, a first phase delay compensation film 123a of 0 RT can be disposed between the first polarizing plate 122a and the viewing angle control layer 129. However, the present disclosure is not limited thereto. The first phase delay compensation film 123a can be excluded in some instances.

In addition, for example, a first protective layer 124a can be disposed between the first phase delay compensation film 123a and the viewing angle control layer 129. However, the present disclosure is not limited thereto. The first protective layer 124a can be excluded in some instances. For example, the first protective layer 124a can be made of silicon nitride having a water vapor transmittance rate (WVTR) of 10⁻³-10⁻² g/m²·day to protect the lower electrode 125a from moisture. However, the present disclosure is not limited thereto.

For example, a second phase delay compensation film 123b of 0 RT can be disposed between the second polarizing plate 122b and the viewing angle control layer 129. However, the present disclosure is not limited thereto. The second phase delay compensation film 123b can be excluded in some instances.

In addition, for example, a second protective layer 124b can be disposed between the second phase delay compensation film 123b and the viewing angle control layer 129. However, the present disclosure is not limited thereto. The second protective layer 124b can be excluded in some instances. For example, the second protective layer 124b can be made of silicon nitride having a WVTR of 10⁻³-10⁻² g/m²·day to protect the upper electrode 125b from moisture. However, the present disclosure is not limited thereto.

Further, the viewing angle control layer 129 can include the lower electrode 125a, the upper electrode 125b, and a liquid crystal layer 126 disposed between the lower electrode 125a and the upper electrode 125b.

In this case, for example, the lower electrode 125a can be configured in the form of a through-electrode over the display area AA. However, the present disclosure is not limited thereto. For example, the lower electrode 125a can extend to the non-display area NA and overlap a part of the non-display area NA.

In contrast, for example, the upper electrode 125b can be configured in a plurality of bar shapes parallel to one another in one direction over the display area AA. However, the present disclosure is not limited thereto. FIG. 4A illustrates an example in which the upper electrode 125b is disposed in a direction parallel to the data line, and FIG. 4B illustrates an example in which the upper electrode 125b is disposed in a direction parallel to the gate line. However, the present disclosure is not limited thereto. In this case, the parallel direction can include not only the same direction but also substantially the same direction, i.e., the same direction set in consideration of a process error. In addition, in case that the upper electrode 125b is disposed in the direction parallel to the data line, as illustrated in FIG. 4A, the privacy mode can be implemented in a leftward/rightward direction. In case that the upper electrode 125b is disposed in the direction parallel to the gate line, as illustrated in FIG. 4B, the privacy mode can be implemented in the upward/downward direction.

In addition, for example, the upper electrode 125b can be configured in a plurality of bar shapes parallel to one another at predetermined intervals.

The upper electrode 125b and the lower electrode 125a can each be made of a transparent conductive material with an excellent transmittance rate, e.g., at least one of indium-tin-oxide (ITO), indium-zinc-oxide (IZO), carbon nanotubes, metal nanowires, and poly(3,4-ethylenedioxythiophene) (PEDOT).

Meanwhile, the liquid crystal layer 126 can be made of a twisted nematic (TN) liquid crystal with a high response speed.

The twisted nematic liquid crystals have molecules disposed in a spiral shape. The directions of the molecules are rotated for each layer, such that the spiral structure rotated as a whole can be formed.

In addition, when a voltage is applied to the twisted nematic liquid crystals, the rotations of the liquid crystal molecules can be changed, and the rotations of the molecules can be used to control the transmittance rate of the light. For example, when no voltage is applied, the light can be rotated by the spiral structure, and the propagation direction of the transmitted light can be rotated.

Therefore, as illustrated in FIG. 3A, in case that no electric field is applied between the upper electrode 125b and the lower electrode 125a, the state of the liquid crystal layer 126 is constant in the overall area of the viewing angle control layer 129.

In contrast, as illustrated in FIG. 3B, in case that an electric field is applied between the upper electrode 125b and the lower electrode 125a, the state of the liquid crystal layer 126 in the area in which the upper electrode 125b is disposed and the state of the liquid crystal layer 126 in the area in which the upper electrode 125b is not disposed are different from each other.

First, for example, with reference to FIG. 3A, in case that no electric field is applied between the upper electrode 125b and the lower electrode 125a, the back light having the horizontal polarization of the P-wave enters the viewing angle control panel 120.

In this case, because the first polarizing plate 122a has the transmission axis consistent with the polarization direction of the back light, the back light of the P-wave can pass through the first polarizing plate 122a without a loss.

In addition, in this case, the state of the liquid crystal layer 126 can be constant in the overall area of the viewing angle control layer 129. That is, because the liquid crystal molecules of the liquid crystal layer 126 are rotated in the spiral structure, the propagation direction of the light passing through the first polarizing plate 122a is rotated, such that the polarization direction of the light changes from the P-wave to the S-wave.

In addition, in this case, the light having the polarization direction changed to the S-wave passes, without a loss, through the second polarizing plate 122b having the transmission axis perpendicular to the polarization direction of the back light.

Therefore, in both the area in which the upper electrode 125b is disposed and the area in which the upper electrode 125b is not disposed, the light having the polarization direction changed to the S-wave can pass through the viewing angle control panel 120 and be provided to the display panel, such that the share mode can be implemented.

Next, with reference to FIG. 3B, in case that an electric field is applied between the upper electrode 125b and the lower electrode 125a, the back light having the horizontal polarization of the P-wave enters the viewing angle control panel 120, as described above.

In this case, because the first polarizing plate 122a has the transmission axis consistent with the polarization direction of the back light, the back light of the P-wave can pass through the first polarizing plate 122a without a loss.

In contrast, in this case, the state of the liquid crystal layer 126 in the area in which the upper electrode 125b is disposed and the state of the liquid crystal layer 126 in the area in which the upper electrode 125b is not disposed can be different from each other. That is, in the area in which the upper electrode 125b is not disposed, the state in which the liquid crystal molecules of the liquid crystal layer 126 are rotated in the spiral structure is maintained, and the propagation direction of the light passing through the first polarizing plate 122a is rotated, such that the polarization direction of the light changes from the P-wave to the S-wave. In contrast, in the area in which the upper electrode 125b is disposed, the liquid crystal molecules of the liquid crystal layer 126 are rearranged by the electric field, such that the spiral shapes are released and aligned in a row. Therefore, the light of the P-wave passes through the TN liquid crystal layer 126 without changing the polarized state.

In addition, in this case, the light of the P-wave cannot pass through the second polarizing plate 122b having the transmission axis perpendicular to the polarization direction of the back light.

Therefore, in the area in which the upper electrode 125b is not disposed, the light having the polarization direction changed to the S-wave passes through the viewing angle control panel 120 and is provided to the display panel. In contrast, in the area in which the upper electrode 125b is disposed, the light of the P-wave is blocked by the second polarizing plate 122b, such that the privacy mode can be implemented.

For example, the back light of the P-wave can pass through the first polarizing plate 122a by about 90% while being partially absorbed and pass through the viewing angle control layer 129 by about 80% while being partially absorbed, and the light having the polarization direction changed to the S-wave can finally pass through the second polarizing plate 122b by about 70% while being partially absorbed. In contrast, the light of the P-wave can pass through the second polarizing plate 122b by about 1% while being blocked almost.

In contrast, in the case of a thin film shutter (TFS) using a light source of a non-polarized back light and electrochromic (EC) in the related art, the back light can pass through electrochromic films only by about 35% while being absorbed in a significant amount. Therefore, in the first embodiment of the present disclosure, an improvement of about 3.6 times in visual field luminance can be expected in comparison with the related art.

As described above, in the first embodiment of the present disclosure, it is possible to provide the display device having a switchable viewing angle that can switch between the privacy mode and the share mode by controlling the polarized state and the optical path of the back light source and improve luminance without an increase in power consumption particularly in the share mode.

In addition, it is possible to provide the display device having a switchable viewing angle that can increase a speed of switching between the share mode and the privacy mode by using the TN liquid crystal with a high response speed of controlling the optical path.

Meanwhile, according to the present disclosure, a pixel lens can be added to an upper layer of the viewing angle control panel and collect light to improve efficiency. This configuration will be described in detail with reference to a second embodiment of the present disclosure.

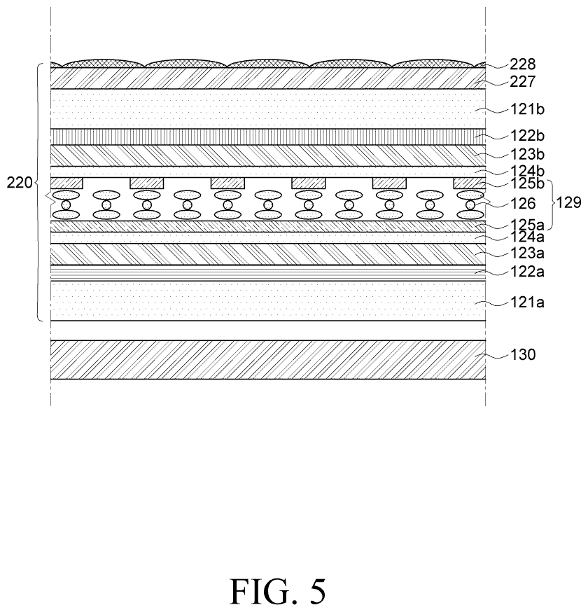

FIG. 5 is a cross-sectional view illustrating a part of a display device having a switchable viewing angle according to a second embodiment of the present disclosure.

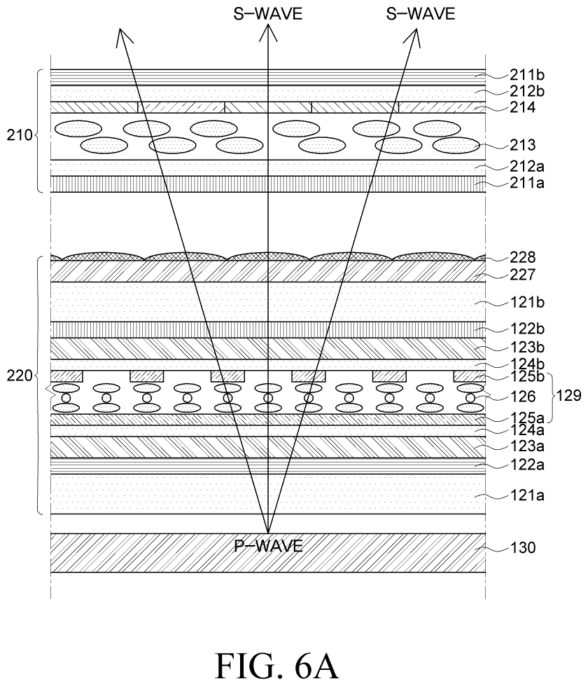

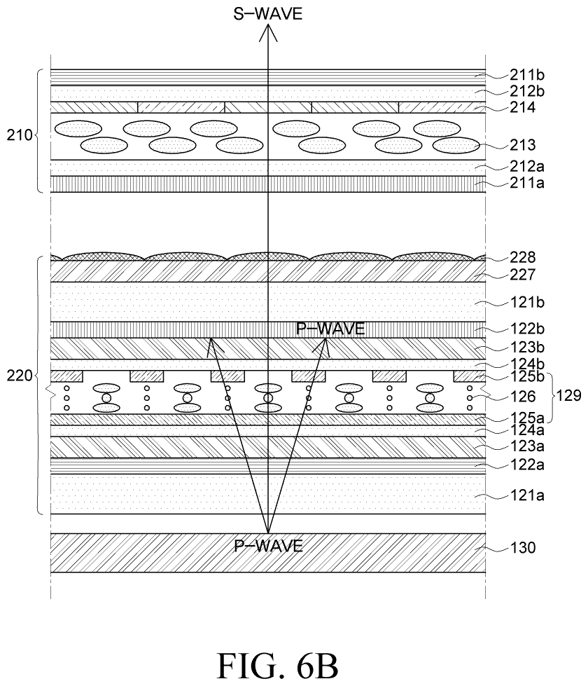

FIG. 6A is a view illustrating a state in which the display device having a switchable viewing angle according to the second embodiment of the present disclosure in FIG. 5 is in the share mode.

FIG. 6B is a view illustrating a state in which the display device having a switchable viewing angle according to the second embodiment of the present disclosure in FIG. 5 is in the privacy mode.

Particularly, FIG. 5 illustrates structures of a viewing angle control panel 220 and the back light unit 130 according to the second embodiment of the present disclosure. In addition, FIGS. 6A and 6B illustrate the display device having a switchable viewing angle according to the second embodiment of the present disclosure, i.e., the structures of the viewing angle control panel 220, the back light unit 130, and a display panel 210.

FIG. 6A illustrates the display device having a switchable viewing angle in a state in which no voltage is applied to the pair of electrodes 125a and 125b. FIG. 6B illustrates the display device having a switchable viewing angle in a state in which a voltage is applied to the pair of electrodes 125a and 125b. FIGS. 6A and 6B illustrate a propagation state of the light at a predetermined point in accordance with whether a voltage is applied. That is, the propagation state of the light on a front surface of the display panel 210 is illustrated.

The configurations in FIGS. 5, 6A, and 6B are substantially identical to the configurations of the first embodiment of the present disclosure in FIGS. 3A, 3B, 4A, and 4B, except that a pixel lens 228 is added to the upper layer of the viewing angle control panel 220, and the display panel 210 is disposed above the viewing angle control panel 220. Therefore, the same reference numerals are assigned to the same components, and a description thereof will be omitted.

Hereinafter, an example will be described in which the display panel 210 is configured as a liquid crystal display panel. However, the present disclosure is not limited thereto.

With reference to FIGS. 5, 6A, and 6B, the display panel 210 can be disposed above the viewing angle control panel 120, and the back light unit 130 can be disposed below the viewing angle control panel 120.

For example, the back light unit 130 according to the second embodiment of the present disclosure can provide light polarized to the P-wave or the S-wave by applying a polarization light source.

Because the back light unit 130 according to the second embodiment of the present disclosure is identical to the back light unit 130 according to the first embodiment of the present disclosure, a description thereof will be omitted.

In the display panel 210 of the second embodiment of the present disclosure, an array substrate 212a and a color filter substrate 212b can be spaced apart from each other and face each other, and a liquid crystal layer 213 can be interposed between the array substrate 212a and the color filter substrate 212b. In this case, for convenience of description, the array substrate 212a and the color filter substrate 212b can be respectively referred to as a first substrate and a second substrate.

A first substrate 212a can include a gate line and a data line configured to define a pixel area while intersecting each other, and a thin-film transistor of a switching element formed in an intersection portion where the gate line and the data line intersect.

In addition, for example, a plurality of common electrodes and a plurality of pixel electrodes can be disposed alternately in pixel areas of the first substrate 212a and implement images.

In addition, a black matrix having opening portions corresponding to the pixel areas can be disposed on a second substrate 212b. A color filter layer 214 including red, green, and blue color filters sequentially and repeatedly arranged to correspond to the opening portions can be disposed on the second substrate 212b.

Further, an overcoating layer can be disposed above the black matrix and the color filter layer 214.

In addition, a lower polarizing plate 211a and an upper polarizing plate 211b can be respectively attached to the outer surface of the first substrate 212a and the outer surface of the second substrate 212b. For convenience of description, the lower polarizing plate 211a and the upper polarizing plate 211b can be respectively referred to as a third polarizing plate and a fourth polarizing plate.

In this case, polarization axes of the third and fourth polarizing plates 211a and 211b can be orthogonal to each other.

As described above, the back light of the P-wave or the S-wave emitted through the back light unit 130 enters the viewing angle control panel 220. FIGS. 6A and 6B illustrate an example in which the back light polarized to the P-wave enters the viewing angle control panel 220. However, the present disclosure is not limited thereto. The back light polarized to the S-wave can enter the viewing angle control panel 220.

Next, the viewing angle control panel 220 according to the second embodiment of the present disclosure can broadly include the viewing angle control layer 129, and the first and second polarizing plates 122a and 122b respectively disposed below and above the viewing angle control layer 129. Further, the viewing angle control panel 220 according to the second embodiment of the present disclosure can further include the pixel lens 228 disposed above the second polarizing plate 122b.

For example, the first polarizing plate 122a can have a transmission axis consistent with a polarization direction of back light. For example, in case that the back light has a horizontal polarization of the P-wave, the first polarizing plate 122a can have a transmission axis of 0° and an absorption axis of 90°.

For example, the second polarizing plate 122b can have a transmission axis perpendicular to the polarization direction of the back light. For example, in case that the back light has the horizontal polarization of the P-wave, the second polarizing plate 122b can have a transmission axis of 90° and an absorption axis of 0°. That is, the transmission axis of the second polarizing plate 122b can be perpendicular to the transmission axis of the first polarizing plate 122a.

For example, the first TAC layer 121a and the second TAC layer 121b can be respectively disposed outside the first polarizing plate 122a and the second polarizing plate 122b. In addition, an adhesive layer can be further disposed outside the second TAC layer 121b. For example, the adhesive layer can include a pressure sensitive adhesive.

For example, the first phase delay compensation film 123a of 0 RT can be disposed between the first polarizing plate 122a and the viewing angle control layer 129. However, the present disclosure is not limited thereto. The first phase delay compensation film 123a can be excluded in some instances.

In addition, for example, the first protective layer 124a can be disposed between the first phase delay compensation film 123a and the viewing angle control layer 129. However, the present disclosure is not limited thereto. The first protective layer 124a can be excluded in some instances.

For example, the second phase delay compensation film 123b of 0 RT can be disposed between the second polarizing plate 122b and the viewing angle control layer 129. However, the present disclosure is not limited thereto. The second phase delay compensation film 123b can be excluded in some instances.

In addition, for example, the second protective layer 124b can be disposed between the second phase delay compensation film 123b and the viewing angle control layer 129. However, the present disclosure is not limited thereto. The second protective layer 124b can be excluded in some instances.

Further, the viewing angle control layer 129 can include the lower electrode 125a, the upper electrode 125b, and the liquid crystal layer 126 disposed between the lower electrode 125a and the upper electrode 125b.

In this case, for example, the lower electrode 125a can be configured in the form of a through-electrode over the display area AA. However, the present disclosure is not limited thereto. For example, the lower electrode 125a can extend to the non-display area NA and overlap a part of the non-display area NA.

In contrast, for example, the upper electrode 125b can be configured in a plurality of bar shapes parallel to one another in one direction over the display area AA. However, the present disclosure is not limited thereto.

In addition, for example, the upper electrode 125b can be configured in a plurality of bar shapes parallel to one another at predetermined intervals.

The upper electrode 125b and the lower electrode 125a can each be made of a transparent conductive material with an excellent transmittance rate, e.g., at least one of indium-tin-oxide (ITO), indium-zinc-oxide (IZO), carbon nanotubes, metal nanowires, and poly(3,4-ethylenedioxythiophene) (PEDOT).

Meanwhile, the liquid crystal layer 126 can be made of a twisted nematic (TN) liquid crystal with a high response speed.

In addition, as illustrated in FIG. 6A, in case that no electric field is applied between the upper electrode 125b and the lower electrode 125a, the state of the liquid crystal layer 126 is constant in the overall area of the viewing angle control layer 129.

In contrast, as illustrated in FIG. 6B, in case that an electric field is applied between the upper electrode 125b and the lower electrode 125a, the state of the liquid crystal layer 126 in the area in which the upper electrode 125b is disposed and the state of the liquid crystal layer 126 in the area in which the upper electrode 125b is not disposed are different from each other.

First, for example, with reference to FIG. 6A, in case that no electric field is applied between the upper electrode 125b and the lower electrode 125a, the back light having the horizontal polarization of the P-wave enters the viewing angle control panel 220. Hereinafter, for convenience, a motion of the back light of the P-wave entering the viewing angle control panel 220 at one point on the back light unit 130 will be described as an example.

In this case, because the first polarizing plate 122a has the transmission axis consistent with the polarization direction of the back light, the back light of the P-wave can pass through the first polarizing plate 122a without a loss. For example, the back light of the P-wave entering the viewing angle control panel 220 at one point on the back light unit 130 can pass through the first polarizing plate 122a in both the direction toward the center and the leftward/rightward direction.

In addition, in this case, the state of the liquid crystal layer 126 can be constant in the overall area of the viewing angle control layer 129. That is, because the liquid crystal molecules of the liquid crystal layer 126 are rotated in the spiral structure, the propagation direction of the light passing through the first polarizing plate 122a is rotated, such that the polarization direction of the light changes from the P-wave to the S-wave in both the direction toward the center and the leftward/rightward direction. In this case, in both the area in which the upper electrode 125b is disposed and the area in which the upper electrode 125b is not disposed, the light having the polarization direction changed to the S-wave can pass through the viewing angle control panel 120.

In addition, in this case, the light having the polarization direction changed to the S-wave passes, without a loss, through the second polarizing plate 122b having the transmission axis perpendicular to the polarization direction of the back light. For example, the back light propagating from the viewing angle control panel 220 to the second polarizing plate 122b can pass through the second polarizing plate 122b in both the direction toward the center and the leftward/rightward direction.

In addition, in this case, the back light passing through the second polarizing plate 122b in the direction toward the center and the leftward/rightward direction is provided to the display panel 210, such that the share mode can be implemented. That is, not only the back light propagating in the direction toward the center but also the back light propagating in a direction oblique to the leftward/rightward direction is provided to the display panel 210, such that clear, undistorted image quality can be implemented in a wide viewing angle range.

Next, with reference to FIG. 6B, in case that an electric field is applied between the upper electrode 125b and the lower electrode 125a, the back light having the horizontal polarization of the P-wave enters the viewing angle control panel 120, as described above.

In this case, because the first polarizing plate 122a has the transmission axis consistent with the polarization direction of the back light, the back light of the P-wave can pass through the first polarizing plate 122a without a loss. For example, the back light of the P-wave entering the viewing angle control panel 220 at one point on the back light unit 130 can pass through the first polarizing plate 122a in both the direction toward the center and the leftward/rightward direction.

In contrast, in this case, the state of the liquid crystal layer 126 in the area in which the upper electrode 125b is disposed and the state of the liquid crystal layer 126 in the area in which the upper electrode 125b is not disposed can be different from each other. That is, in the area in which the upper electrode 125b is not disposed, the state in which the liquid crystal molecules of the liquid crystal layer 126 are rotated in the spiral structure is maintained, and the propagation direction of the light passing through the first polarizing plate 122a is rotated, such that the polarization direction of the light changes from the P-wave to the S-wave. In this case, the light having the polarization direction changed to the S-wave passes, without a loss, through the second polarizing plate 122b having the transmission axis perpendicular to the polarization direction of the back light. For example, the back light propagating from the viewing angle control panel 220 toward the second polarizing plate 122b in the center direction can pass through the second polarizing plate 122b without a loss.

In contrast, in the area in which the upper electrode 125b is disposed, the liquid crystal molecules of the liquid crystal layer 126 are rearranged by the electric field, such that the spiral shapes are released and aligned in a row. Therefore, the light of the P-wave passes through the TN liquid crystal layer 126 without changing the polarized state. In this case, the light of the P-wave cannot pass through the second polarizing plate 122b having the transmission axis perpendicular to the polarization direction of the back light. For example, the back light propagating from the viewing angle control panel 220 toward the second polarizing plate 122b in the leftward/rightward direction, i.e., the oblique direction is blocked by the second polarizing plate 122b, such that the privacy mode can be implemented. That is, working on confidential documents can be performed or tasks, which require security, can be performed by enabling only the person seated forward of the screen to see images on the screen.

As described above, in the second embodiment of the present disclosure, it is possible to provide the display device having a switchable viewing angle that can switch between the privacy mode and the share mode by controlling the polarized state and the optical path of the back light source and improve luminance without an increase in power consumption particularly in the share mode.

In addition, it is possible to provide the display device having a switchable viewing angle that can increase a speed of switching between the share mode and the privacy mode by using the TN liquid crystal with a high response speed of controlling the optical path.

Meanwhile, the display device having a switchable viewing angle according to the second embodiment of the present disclosure can further include the pixel lens 228 disposed on the upper layer of the viewing angle control panel 220.

For example, a lens assembly can be disposed above the second polarizing plate 122b. For example, the lens assembly can include a plurality of pixel lenses 228 disposed on a substrate 227. The lens assembly can be positioned on a route for the light emitted from the back light unit 130.

A bottom surface of each of the pixel lenses 228 directed toward the second polarizing plate 122b can be a flat surface. A surface of each of the pixel lenses 228 opposite to the display panel 210 can be a semicircular shape. However, the present disclosure is not limited thereto. The plurality of pixel lenses 228 can be positioned side by side. For example, the lens assembly can include a lenticular lens.

For example, the pixel area of the display panel 210 can overlap one of the pixel lenses 228. Therefore, in the display device having a switchable viewing angle according to the second embodiment of the present disclosure, the back light can pass through one of the pixel lenses 228, be discharged to the pixel area, and be provided to the user. Therefore, in the display device having a switchable viewing angle according to the second embodiment of the present disclosure, center luminance of the pixel area can be improved.

The lens assembly can further include a cover layer configured to cover the pixel lens 228. The cover layer can suppress damage to the pixel lens 228 caused by external impact. For example, a semicircular surface of each of the pixel lenses 228 can be completely covered by the cover layer. The cover layer can remove a level difference caused by the pixel lenses 228. For example, the cover layer can include an insulating material.

For example, the plurality of pixel lenses 228 can be disposed at predetermined intervals in the direction parallel to the data line, and the pixel lenses 228 can each be configured in a plurality of bar shapes. However, the present disclosure is not limited thereto.

For example, the pixel lenses 228 can each be disposed to correspond to an area, i.e., non-pattern area between the upper electrodes 125b.

In addition, for example, the pixel lenses 228 can be disposed to respectively correspond to the red, green, and blue color filters of the color filter layer 214.

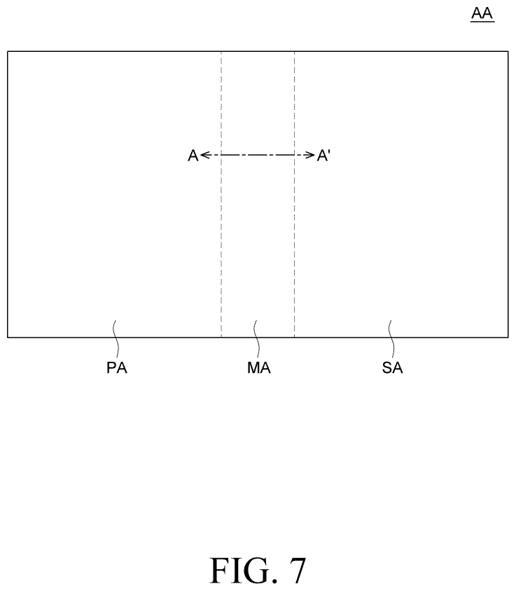

FIG. 7 is a top plan view illustrating a viewing angle control area, a share area, and a boundary area between the two areas of the display device.

Under various environments in which the user uses the display device, it is sometimes necessary to allow a partial area of the display device to control and display the viewing angle and allow the remaining area not to control the viewing angle.

For example, in the case of the display device installed at the front side of the vehicle, the screen in the driver seat can be seen by both the driver and a user in the auxiliary seat. In the case of an entertainment screen such as images watched by the user in the auxiliary seat, a viewing angle can be controlled so that the driver cannot see the entertainment screen because the entertainment screen can hinder the driver from driving the vehicle.

This is because when the driver is driving the vehicle, any images that attract the driver's attention can interfere with safe driving.

In another example of use, in case that the user is using a monitor, a laptop computer, or a tablet, some content may not be intended to be seen by others due to privacy concerns.

In addition to the situations described above, there can be various usage environments. In various usage environments, a viewing angle control area PA of the display device that limits the viewing angle can be flexible, and there can be cases in which viewing angle restriction is required in selective areas.

As described above, in case that the area is divided into the viewing angle control area PA for restricting the viewing angle and a share area SA in the display area, heterogeneity of a boundary portion between the viewing angle control area PA and the share area SA can be increased, which can reduce the user's immersion and the display quality of the display device.

FIG. 7 illustrates the viewing angle control area PA and the share area SA of the display area AA of the display device and a boundary area MA between the two areas. The viewing angle control area PA can have various shapes such as a circular shape and a quadrangular shape in the display area AA. The position of the viewing angle control area PA can also be any position inside the display area AA.

FIG. 7 briefly illustrates the three areas described above. It is noted that there can be various modified embodiments.

In case that images are displayed at different viewing angles in the viewing angle control area PA and the share area SA as described above, the boundary portion becomes more noticeable because of a difference in viewing angles between the areas having different viewing angles in accordance with the positions of the viewer. Hereinafter, various configurations for minimizing the difference will be described.

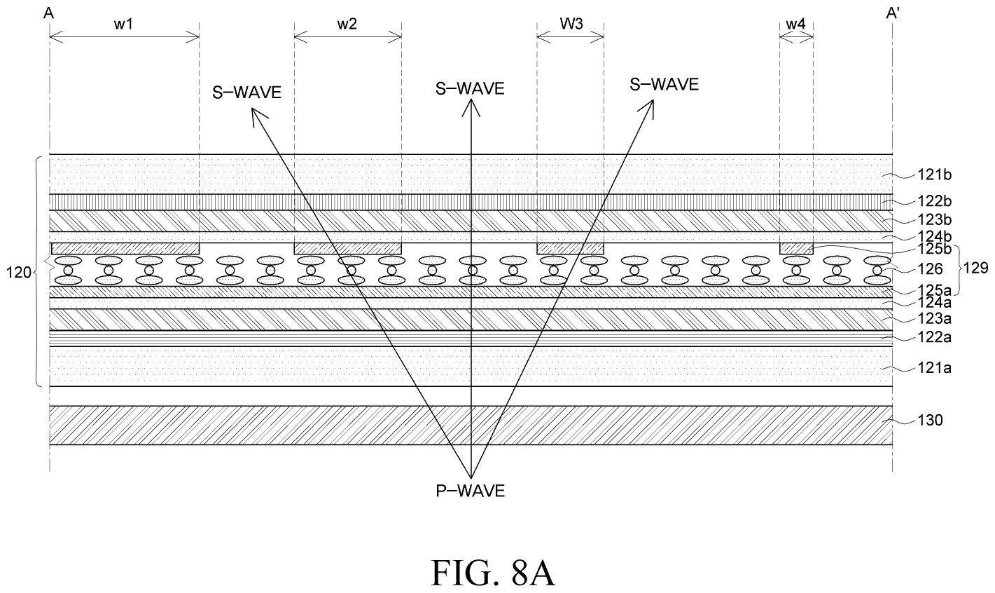

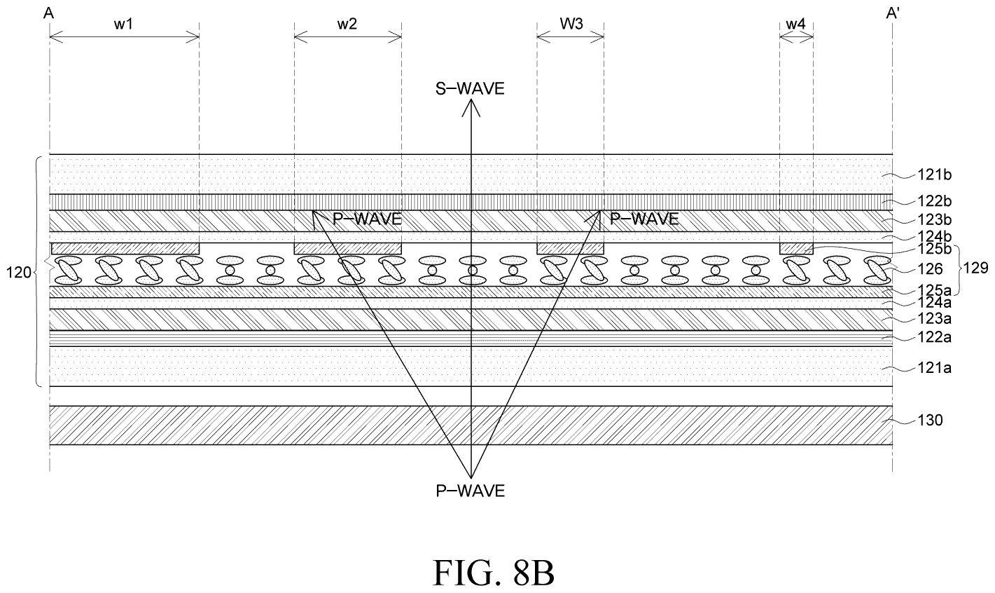

FIGS. 8A and 8B are schematic cross-sectional views of the viewing angle control panel taken along line A to A′ in FIG. 7.

A method of minimizing a visuality difference between the viewing angle control area PA and the share area SA in the boundary area MA will be described with reference to FIGS. 8A and 8B. A description of the constituent elements substantially identical to the previously described constituent elements will be omitted.

Particularly, FIGS. 8A and 8B illustrate a part of the display device having a switchable viewing angle from which the display panel is excluded. The display panel can be disposed on the upper or lower portion of the viewing angle control panel 120 or attached, in an add-on shape, to the upper or lower portion of the viewing angle control panel 120. The display panel can be a liquid crystal display panel or an organic light-emitting display panel. In case that the display panel is a liquid crystal display panel, the display panel can further include a light source, such as a back light unit, disposed below the viewing angle control panel 120. Hereinafter, the embodiment will be described with reference to the embodiment in which a liquid crystal display panel is used as the display panel.

With reference to FIGS. 8A and 8B, the viewing angle control panel 120 includes the viewing angle control layer 129 including the second polarizing plate 122b parallel to the first polarizing plate 122a and having the transmission axis perpendicular to the first polarizing plate 122a, the viewing angle control layer 129 being provided between the first polarizing plate 122a and the second polarizing plate 122b. The viewing angle control layer 129 includes the liquid crystal layer 126 provided between at least one lower electrode 125a and a plurality of upper electrodes 125b.

An alignment film can be further provided on the lower electrode 125a. However, in the present specification, a detailed description of the alignment film will be omitted.

The first TAC (triacetate cellulose) layer 121a and the second TAC layer 121b can be respectively disposed outside the first polarizing plate 122a and the second polarizing plate 122b. In addition, an adhesive layer can be further disposed outside the second TAC layer 121b.

Further, a lens assembly can be disposed above the second polarizing plate 122b. For example, the lens assembly can include the plurality of pixel lenses 228 disposed on the substrate 227 as shown in FIG. 6A and FIG. 6B.

The area illustrated in FIGS. 8A and 8B is a cross-section corresponding to the boundary area MA, a boundary A is adjacent to the viewing angle control area PA, and a boundary A′ is adjacent to the share area SA.

In the boundary area MA, a width of the upper electrode 125b increases as the upper electrode 125b becomes adjacent to the viewing angle control area PA, and a width of the electrode relatively decreases as the electrode becomes adjacent to the share area SA.

Meanwhile, the share area SA may not include the upper electrode 125b. However, the present disclosure is not limited thereto. As necessary, an electrode, which is made of the same material as the upper electrode 125b, can be disposed as a dummy electrode to which no power is applied in order to minimize a visuality difference between the viewing angle control area PA, the boundary area MA, and the share area SA.

In case that the share area SA includes the upper electrode 125b, the upper electrode 125b can be a dummy electrode. The dummy electrode can minimize a visuality difference in accordance with the reflection of external light and minimize a visuality difference in accordance with the transmittance rate of the light emitted from the back light unit 130.

In various modified embodiment, the dummy electrode can maintain a predetermined voltage regardless of the viewing angle control mode or the share mode. In addition, the dummy electrode can extend to an outer periphery of the viewing angle control panel. The dummy electrode can be connected to the ground electrode or configured to maintain a predetermined voltage to the dummy electrode in order to reduce an erroneous operation of the viewing angle control panel caused by static electricity or the like.

The plurality of upper electrodes 125b of the share area SA can be configured in a plurality of bar shapes parallel to one direction, and the lower electrode 125a can be configured in a through-electrode shape over the display area AA. The plurality of upper electrodes 125b can be disposed in the direction parallel to the gate line and, as necessary, disposed in the direction parallel to the data line.

The upper electrode 125b disposed in the boundary area MA is an electrode for implementing the privacy mode disposed in the direction parallel to the gate line. The upper electrode 125b and the lower electrode 125a can each be made of a transparent conductive material with an excellent transmittance rate, e.g., at least one of indium-tin-oxide (ITO), indium-zinc-oxide (IZO), carbon nanotubes, metal nanowires, and poly(3,4-ethylenedioxythiophene) (PEDOT).

Meanwhile, the liquid crystal layer 126 can be made of a twisted nematic (TN) liquid crystal with a high response speed.

The twisted nematic liquid crystals have molecules disposed in a spiral shape. The directions of the molecules are rotated for each layer, such that the spiral structure rotated as a whole can be formed.

In addition, when a voltage is applied to the twisted nematic liquid crystals, the rotations of the liquid crystal molecules can be changed, and the rotations of the molecules can be used to control the transmittance rate of the light. For example, when no voltage is applied, the light can be rotated by the spiral structure, and the propagation direction of the transmitted light can be rotated.

Therefore, as illustrated in FIG. 8A, in case that no electric field is applied between the upper electrode 125b and the lower electrode 125a, the state of the liquid crystal layer 126 is constant in the overall area of the viewing angle control layer 129.

In contrast, as illustrated in FIG. 8B, in case that an electric field is applied between the upper electrode 125b and the lower electrode 125a, the state of the liquid crystal layer 126 in the area in which the upper electrode 125b is disposed and the state of the liquid crystal layer 126 in the area in which the upper electrode 125b is not disposed are different from each other.

A configuration of the route for light will be described. First, as illustrated in FIG. 8A, in case that no electric field is applied between the upper electrode 125b and the lower electrode 125a, the back light having the horizontal polarization of the P-wave enters the viewing angle control panel 120 from the back light unit 130.

In this case, because the first polarizing plate 122a has the transmission axis consistent with the polarization direction of the back light, the back light of the P-wave can pass through the first polarizing plate 122a without a loss.

In addition, in this case, the state of the liquid crystal layer 126 can be constant in the overall area of the viewing angle control layer 129. The molecules of the twisted nematic liquid crystals are disposed in spiral shapes. Because the liquid crystal molecules of the liquid crystal layer 126 are rotated in the spiral structure, the propagation direction of the light passing through the first polarizing plate 122a is rotated, such that the polarization direction of the light changes from the P-wave to the S-wave.

In addition, in this case, the light having the polarization direction changed to the S-wave passes, without a loss, through the second polarizing plate 122b having the transmission axis perpendicular to the polarization direction of the back light.

Therefore, in both the area in which the upper electrode 125b is disposed and the area in which the upper electrode 125b is not disposed, the light having the polarization direction changed to the S-wave can pass through the viewing angle control panel 120 and be provided to the display panel, such that the share mode can be implemented.

Next, with reference to FIG. 8B, in case that an electric field is applied between the upper electrode 125b and the lower electrode 125a, the back light having the horizontal polarization of the P-wave enters the viewing angle control panel 120, as described above.

In this case, because the first polarizing plate 122a has the transmission axis consistent with the polarization direction of the back light, the back light of the P-wave can pass through the first polarizing plate 122a without a loss.

In contrast, in this case, the state of the liquid crystal layer 126 in the area in which the upper electrode 125b is disposed and the state of the liquid crystal layer 126 in the area in which the upper electrode 125b is not disposed can be different from each other. That is, in the area in which the upper electrode 125b is not disposed, the state in which the liquid crystal molecules of the liquid crystal layer 126 are rotated in the spiral structure is maintained, and the propagation direction of the light passing through the first polarizing plate 122a is rotated, such that the polarization direction of the light changes from the P-wave to the S-wave. In contrast, in the area in which the upper electrode 125b is disposed, the liquid crystal molecules of the liquid crystal layer 126 are rearranged by the electric field, such that the spiral shapes are released and aligned in a row. Therefore, the light of the P-wave passes through the TN liquid crystal layer 126 without changing the polarized state.

In addition, in this case, the light of the P-wave cannot pass through the second polarizing plate 122b having the transmission axis perpendicular to the polarization direction of the back light.

Therefore, in the area in which the upper electrode 125b is not disposed, the light having the polarization direction changed to the S-wave passes through the viewing angle control panel 120 and is provided to the display panel. In contrast, in the area in which the upper electrode 125b is disposed, the light of the P-wave is blocked by the second polarizing plate 122b, such that the privacy mode can be implemented.

As illustrated in FIG. 8B, the upper electrodes 125b can be disposed as electrodes having different widths (or areas) in the boundary area MA. The area of the electrode can be widened as the electrode becomes adjacent to the viewing angle control area PA, and the area of the electrode can be narrowed as the electrode becomes adjacent to the share area SA.

As described above, the upper electrodes 125b can be disposed to have different areas in the boundary area MA. For example, a first width W1 can be larger than a second width W2, the second width W2 can be larger than a third width W3, and the third width W3 can be larger than a fourth width W4.

With the above-mentioned configuration, because the width of the upper electrode 125b of the boundary area MA increases toward the viewing angle control area PA and decreases toward the share area SA, the viewing angle of the light, which passes through the viewing angle control panel 120 and is provided to the display panel in the viewing angle control mode, decreases toward the viewing angle control area PA and increases toward the share area SA.

As described above, in the case of a viewing angle restriction mode in the state in which the upper electrodes 125b are disposed to have different widths, an effect of controlling the viewing angle is improved as the electrode becomes adjacent to the viewing angle control area PA, and the effect of controlling the viewing angle deteriorates as the electrode becomes adjacent to the share area SA.

As described above, the width of the upper electrode 125b corresponding to the boundary area MA gradually decreases in the direction toward the share area SA, such that visual inconsistency caused by a viewing angle restriction difference between the viewing angle control area PA and the share area SA can be reduced.

According to the effect implemented by the above-mentioned configuration, when the display device 100 having a switchable viewing angle operates in the viewing angle control mode, visual inconsistency of the boundary portion caused by the difference in viewing angle between the viewing angle control area PA and the share area SA can be minimized in the boundary area MA.

Hereinafter, another configuration, which is different from the configuration of the above-mentioned embodiment and can reduce a visuality difference, will be described.

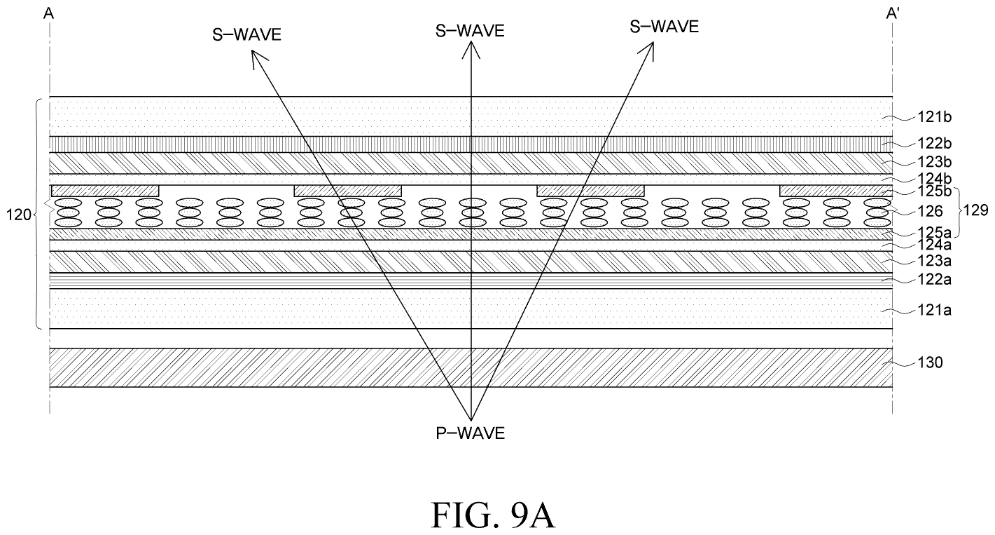

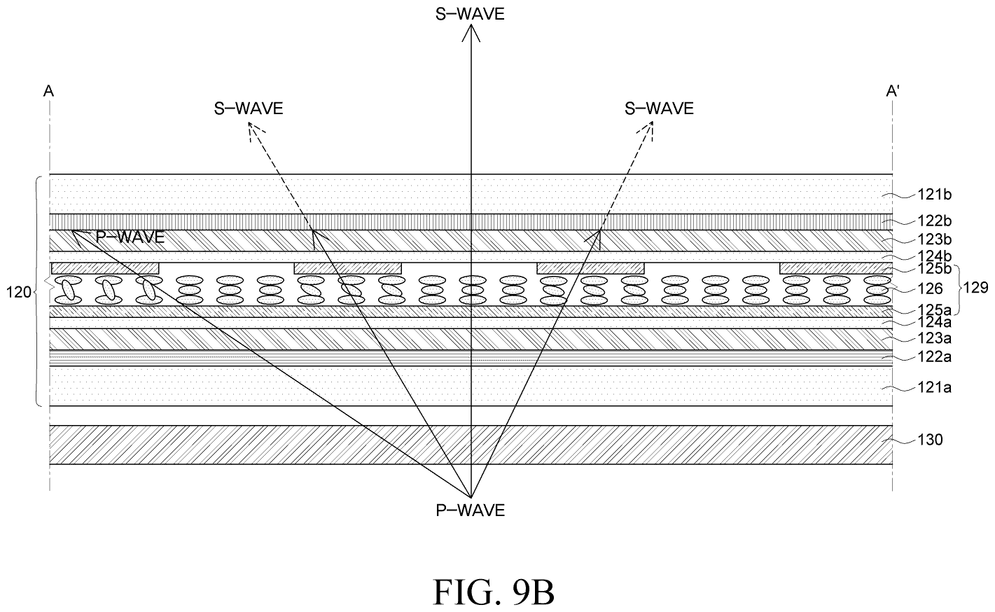

FIGS. 9A and 9B are schematic cross-sectional views for explaining another configuration of the viewing angle control panel taken along line A to A′ in FIG. 7.

Another method of minimizing a visuality difference between the viewing angle control area PA and the share area SA in the boundary area MA will be described with reference to FIGS. 9A and 9B. A description of the constituent elements substantially identical to the previously described constituent elements will be omitted.

FIGS. 9A and 9B illustrate a part of the display device having a switchable viewing angle from which the display panel is excluded. The display panel can be disposed on the upper or lower portion of the viewing angle control panel 120 or attached, in an add-on shape, to the upper or lower portion of the viewing angle control panel 120. In case that the display panel is a liquid crystal display panel, the display panel can further include a light source, such as a back light unit, disposed below the viewing angle control panel 120. Hereinafter, the embodiment will be described with reference to the example in which a liquid crystal display panel is used as the display panel.

With reference to FIGS. 9A and 9B, the viewing angle control panel 120 includes the viewing angle control layer 129 including the second polarizing plate 122b parallel to the first polarizing plate 122a and having the transmission axis perpendicular to the first polarizing plate 122a, the viewing angle control layer 129 being provided between the first polarizing plate 122a and the second polarizing plate 122b. The viewing angle control layer 129 includes the liquid crystal layer 126 provided between at least one lower electrode 125a and a plurality of upper electrodes 125b.

An alignment film can be further provided on the lower electrode 125a. However, in the present specification, a detailed description of the alignment film will be omitted.

The first TAC (triacetate cellulose) layer 121a and the second TAC layer 121b can be respectively disposed outside the first polarizing plate 122a and the second polarizing plate 122b. In addition, an adhesive layer can be further disposed outside the second TAC layer 121b.

A lens assembly can be disposed above the second polarizing plate 122b. For example, the lens assembly can include the plurality of pixel lenses 228 disposed on the substrate 227.

The area illustrated in FIGS. 9A and 9B corresponds to the boundary area MA, a boundary line A is adjacent to the viewing angle control area PA, and a boundary line A′ is adjacent to the share area SA.

In the embodiment described with reference to FIGS. 9A and 9B, the viewing angle control area PA and the share area SA can be flexibly changed in the display area AA. As illustrated in FIG. 7, the viewing angle control area PA and the share area SA can be disposed at left and right sides with the boundary area MA interposed therebetween. However, the present disclosure is not limited thereto. The viewing angle control area PA can have a quadrangular shape, a circular shape, or a polygonal shape in the display area AA. In this case, the boundary area MA can be positioned on a boundary between the viewing angle control area PA and the share area SA.

Because the viewing angle control area PA and the share area SA are flexible, the plurality of upper electrodes 125b in the present embodiment can be structured to be connected to the data electrode and the gate electrode. The plurality of upper electrodes 125b can be active matrix-type pixel electrodes to which a voltage is actively applied to in accordance with data signals and signals of the gate electrode.

The case in FIG. 9A in which no electric field is applied between the upper electrode 125b and the lower electrode 125a will be described with reference to FIGS. 9A and 9B. The back light having the horizontal polarization of the P-wave enters the viewing angle control panel 120.

In this case, because the first polarizing plate 122a has the transmission axis consistent with the polarization direction of the back light, the back light of the P-wave can pass through the first polarizing plate 122a without a loss.

In addition, in this case, the state of the liquid crystal layer 126 can be constant in the overall area of the viewing angle control layer 129. That is, because the liquid crystal molecules of the liquid crystal layer 126 are rotated in the spiral structure, the propagation direction of the light passing through the first polarizing plate 122a is rotated, such that the polarization direction of the light changes from the P-wave to the S-wave.

In addition, in this case, the light having the polarization direction changed to the S-wave passes, without a loss, through the second polarizing plate 122b having the transmission axis perpendicular to the polarization direction of the back light.

Therefore, in both the area in which the upper electrode 125b is disposed and the area in which the upper electrode 125b is not disposed, the light having the polarization direction changed to the S-wave can pass through the viewing angle control panel 120 and be provided to the display panel, such that the share mode can be implemented.

Next, the viewing angle control mode will be described with reference to the case in which an electric field is applied between the upper electrode 125b and the lower electrode 125a, as illustrated in FIG. 9B.

The back light having the horizontal polarization of the P-wave enters the viewing angle control panel 120. Because the first polarizing plate 122a has the transmission axis consistent with the polarization direction of the back light, the back light of the P-wave can pass through the first polarizing plate 122a without a loss.

In case that an electric field is applied to the upper electrode 125b, as illustrated in FIG. 9B, the state of the liquid crystal layer 126 in the area in which the upper electrode 125b is disposed and the state of the liquid crystal layer 126 in the area in which the upper electrode 125b is not disposed can be different from each other. That is, in the area in which the upper electrode 125b is not disposed, the state in which the liquid crystal molecules of the liquid crystal layer 126 are rotated in the spiral structure is maintained, and the propagation direction of the light passing through the first polarizing plate 122a is rotated, such that the polarization direction of the light changes from the P-wave to the S-wave. In contrast, in the area in which the upper electrode 125b is disposed, the liquid crystal molecules of the liquid crystal layer 126 are rearranged by the electric field, such that the spiral shapes are released and rearranged. Therefore, the light of the P-wave passes through the TN liquid crystal layer 126 without changing the polarized state.

In addition, in this case, the light of the P-wave cannot pass through the second polarizing plate 122b having the transmission axis perpendicular to the polarization direction of the back light.

Therefore, in the area in which the upper electrode 125b is not disposed, the light having the polarization direction changed to the S-wave passes through the viewing angle control panel 120 and is provided to the display panel. In contrast, in the area in which the upper electrode 125b is disposed, the light of the P-wave is blocked by the second polarizing plate 122b, such that the privacy mode can be implemented.

In this case, a voltage of 0 V (Volt) to 5 V (Volt) of an electric current can be applied to the upper electrode 125b corresponding to the boundary area MA, and a voltage of 5 V or more can be applied to in accordance with the type of liquid crystal, which is used for the liquid crystal layer 126, and the structures of the upper and lower electrodes 125b and 125a.

In the embodiment of the present specification, different voltages can be applied to the upper electrode 125b in the boundary area MA. The voltage can be applied such that the voltage increases as the electrode becomes adjacent to the viewing angle control area PA, and the applies voltage decreases as the electrode becomes adjacent to the share area SA.

As described above, in case that the voltage, which gradually decreases in the direction from the viewing angle control area PA toward the share area SA, is applied to the upper electrode 125b, the effect of controlling the viewing angle is improved as the electrode becomes adjacent to the viewing angle control area PA, and the effect of controlling the viewing angle deteriorates as the electrode becomes adjacent to the share area SA.

The liquid crystal layer 126 can include the twisted nematic (TN) liquid crystal. When a voltage is applied to the liquid crystal layer 126, the rotations of the liquid crystal molecules are changed, and the rotations of the liquid crystal molecules vary depending on a difference in voltages. The transmittance rate of the light can be controlled in accordance with the rotations of the molecules.

For example, in case that a low voltage is applied, the spiral structure changes less, such that the amount of light, which is introduced as the P-wave and converted into the S-wave, relatively increases. Therefore, the transmittance rate at a position at which the upper electrode 125b is disposed increases, such that the effect of controlling the viewing angle deteriorates. On the contrary, in case that a voltage, which gradually increases, is applied, the change in the spiral structure increases, such that the amount of light, which is introduced as the P-wave and converted into the S-wave, relatively decreases. Therefore, the transmittance rate at a position at which the upper electrode 125b is disposed decreases, such that the effect of controlling the viewing angle is improved.

FIG. 9B utilizes this feature. In order to reduce a visuality difference in the boundary area MA between the viewing angle control area PA and the share area SA, a relatively high voltage is applied to the upper electrode 125b adjacent to the viewing angle control area PA among the plurality of upper electrodes 125b, and a relatively low voltage is applied to the upper electrode 125b adjacent to the share area SA. As described above, it is possible to minimize the visuality difference by gradually changing the viewing angle restriction effect by gradually increasing or decreasing the voltage applied to the upper electrode 125b.

In case that different voltages are applied as described above, the voltage applied to the upper electrode 125b in the boundary area MA increases as the electrode becomes adjacent to the viewing angle control area PA in the viewing angle control mode, and the voltage decreases as the electrode becomes adjacent to the share area SA. The voltage applied to the upper electrode 125b in the boundary area MA cannot be higher than the voltage applied to the upper electrode 125b corresponding to the viewing angle control area PA and cannot be lower than the voltage applied to the upper electrode 125b corresponding to the share area SA.

As described above, the method of applying different voltages to the upper electrode 125b corresponding to the boundary area MA according to one or more embodiments of the present disclosure can minimize a visuality difference in accordance with a difference in the effect of controlling the viewing angle.

Although the embodiments of the present disclosure have been described in detail with reference to the accompanying drawings, the present disclosure is not limited thereto and can be embodied in many different forms without departing from the technical concept of the present disclosure. Therefore, the embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present disclosure. All the technical concepts in the equivalent scope of the present disclosure should be construed as falling within the scope of the present disclosure.

What is claimed is:

1. A display device having a switchable viewing angle, the display device comprising:
a display panel comprising a display area and a non-display area around the display area, the display area including a viewing angle control area in which the display device is operated to be switched between a viewing angle control mode and a share mode, a share area in which the display device is operated in the share mode, and a boundary area disposed between the viewing angle control area and the share area and in which the display device is operated to be switched between the viewing angle control mode and the share mode; and
a viewing angle control panel disposed below the display panel and configured to selectively control an operating mode of the display device by controlling a polarized light transmitting into the display area,
wherein, in an area of the viewing angle control panel corresponding to the boundary area, the viewing angle control panel is configured so that an amount of the polarized light from a light source of the display device blocked by the viewing angle control panel gradually decreases in a direction from the viewing angle control area to the share area.

2. A display device having a switchable viewing angle, the display device comprising:
a display panel comprising a display area and a non-display area around the display area, the display area including a viewing angle control area in which the display device is operated to be switched between a viewing angle control mode and a share mode, a share area in which the display device is operated in the share mode, and a boundary area disposed between the viewing angle control area and the share area and in which the display device is operated to be switched between the viewing angle control mode and the share mode; and
a viewing angle control panel disposed below the display panel and configured to selectively control an operating mode of the display device,
wherein the viewing angle control panel comprises:
a first polarizing plate;
a viewing angle control layer disposed on the first polarizing plate; and
a second polarizing plate disposed on the viewing angle control layer, and having a transmission axis perpendicular to a transmission axis of the first polarizing plate,
wherein the viewing angle control layer comprises a plurality of upper electrodes, at least one lower electrode, and a liquid crystal layer disposed between the plurality of upper electrodes and the at least one lower electrode, and
wherein, in an area of the viewing angle control panel corresponding to the boundary area, a width of each of the plurality of upper electrodes in a direction from the viewing angle control area to the share area gradually decreases in a direction from the viewing angle control area to the share area.

3. The display device of claim 2, wherein in an area of the viewing angle control layer corresponding to the share area, the viewing angle control layer is configured only by the at least one lower electrode and the liquid crystal layer.

4. The display device of claim 2, wherein in an area of the viewing angle control layer corresponding to the share area, at least one of the plurality of upper electrodes is a dummy electrode with no power applied thereto.

5. The display device of claim 4, wherein the dummy electrode is a ground electrode.

6. The display device of claim 2, wherein the plurality of upper electrodes are configured in a plurality of bar shapes parallel to one another in one direction, and the at least one lower electrode is configured as a through-electrode shape over the display area.

7. The display device of claim 6, wherein the plurality of upper electrodes are disposed in a direction parallel to a data line or a gate line of the display device.

8. The display device of claim 2, wherein a state of the liquid crystal layer is constant in an overall area of the viewing angle control layer when no electric field is applied between an upper electrode among the plurality of upper electrodes and the at least one lower electrode, and
wherein a state of the liquid crystal layer in an area in which the upper electrode is disposed and a state of the liquid crystal layer in an area in which the upper electrode is not disposed are different from each other when an electric field is applied between the upper electrode and the at least one lower electrode.

9. The display device of claim 2, wherein the at least one lower electrode is extended into the non-display area and overlaps a portion of the non-display area.

10. The display device of claim 2, further comprising:
a plurality of pixel lenses disposed above the second polarizing plate.

11. The display device of claim 10, wherein a bottom surface of each of the plurality of pixel lenses has a flat surface, and a top surface of each of the plurality of pixel lenses has a semicircular shape.

12. A display device having a switchable viewing angle, the display device comprising:
a display panel comprising a display area and a non-display area around the display area, the display area including a viewing angle control area in which the display device is operated to be switched between a viewing angle control mode and a share mode, a share area in which the display device is operated in the share mode, and a boundary area disposed between the viewing angle control area and the share area and in which the display device is operated to be switched between the viewing angle control mode and the share mode; and
a viewing angle control panel disposed below the display panel and configured to selectively control an operating mode of the display device,
wherein the viewing angle control panel comprises:
a first polarizing plate;
a viewing angle control layer disposed on the first polarizing plate; and
a second polarizing plate disposed on the viewing angle control layer and having a transmission axis perpendicular to a transmission axis of the first polarizing plate,
wherein the viewing angle control layer comprises a plurality of upper electrodes, at least one lower electrode and a liquid crystal layer disposed between the plurality of upper electrodes and the at least one lower electrode, and
wherein, in an area of the viewing angle control panel corresponding to the boundary area, a voltage applied to the plurality of upper electrodes in the viewing angle control mode is applied in a manner that the voltage gradually decreases in a direction from the viewing angle control area to the share area.

13. The display device of claim 12, wherein in an area of the viewing angle control layer corresponding to the share area, an upper electrode among the plurality of upper electrodes maintains a predetermined voltage regardless of the operating mode.

14. The display device of claim 12, wherein in an area of the viewing angle control layer corresponding to the share area, the upper electrode is a dummy electrode.

15. The display device of claim 14, wherein the dummy electrode is a ground electrode.

16. The display device of claim 12, wherein the plurality of upper electrodes are configured in a plurality of bar shapes parallel to one another in one direction, and the at least one lower electrode is configured as a through-electrode shape over the display area.

17. The display device of claim 16, wherein the plurality of upper electrodes are disposed in a direction parallel to a data line or a gate line of the display device.

18. The display device of claim 12, wherein a state of the liquid crystal layer is constant in an overall area of the viewing angle control layer when no electric field is applied between an upper electrode among the plurality of upper electrodes and the at least one lower electrode, and
wherein a state of the liquid crystal layer in an area in which the upper electrode is disposed and a state of the liquid crystal layer in an area in which the upper electrode is not disposed are different from each other when an electric field is applied between the upper electrode and the at least one lower electrode.

19. The display device of claim 12, further comprising:
a plurality of pixel lenses disposed above the second polarizing plate,
wherein a bottom surface of each of the plurality of pixel lenses has a flat surface, and a top surface of each of the plurality of pixel lenses has a semicircular shape.

20. A vehicle, comprising the display device according to claim 1.
